(19) United States
(12) Patent Application Publication
(10) Pub. No.: US 2025/0349022 A1
(43) Pub. Date: Nov. 13, 2025

(54) AUTOMATED MONITORING OF VOLUMETRIC PROPERTIES OF WORK PILE MOUNDS

(71) Applicant: Correct-AI Inc., Edmonton (CA)

(72) Inventors: Siamak Akhlaghi Esfahany, Edmonton (CA); Raghav Madan, Edmonton (CA); Tianqi Wang, Edmonton (CA)

(21) Appl. No.: 19/199,596

(22) Filed: May 6, 2025

Related U.S. Application Data
(60) Provisional application No. 63/643,689, filed on May 7, 2024.

(51) Int. Cl. G06T 7/62; G01B 11/22; G01C 21/16; G01S 17/89; G01S 17/931; G06T 17/05

(52) U.S. Cl. CPC G06T 7/62; G01B 11/22; G01C 21/16; G01S 17/89; G01S 17/931; G06T 17/05; G06T 2207/10028; G06T 2207/20021; G06T 2207/30181; G06T 2207/30261

(57) ABSTRACT

Disclosed example generally relate to a method and system for automated monitoring of volumetric properties of work pile mounds. In at least one example, there is provided a method for automated monitoring of volumetric properties of work pile mounds, including obtaining monitoring sensor data of a surrounding environment which includes one or more work pile mounds, wherein the monitoring data comprises depth sensor data and motion sensor data; generating, based on the monitoring data, a three-dimensional (3D) construction of the surrounding environment; determining, based on the 3D construction, at least one volumetric property of a work pile mound in a target area; and generating an output that includes the determined volumetric properties.

### CROSS-REFERENCE TO RELATED APPLICATION(S)

The present application claims priority to, and the benefit of, U.S. Provisional Patent Application No. 63/643,689 titled “METHOD AND SYSTEM FOR AUTOMATED MONITORING OF VOLUMETRIC PROPERTIES OF WORK PILE MOUNDS”, filed on May 7, 2024, the entire contents which are incorporated herein by reference in their entirety.

### FIELD

Various examples are described herein that generally relate to determining volumetric properties of work pile mounds (e.g., dirt piles at construction sites), and in particular, to a method and system for automated monitoring of volumetric properties of work pile mounds.

### BACKGROUND

Construction projects often require excavating ground dirt and other materials (e.g., rocks). This includes, for example, excavating large ground areas in preparation for constructing buildings, as well as excavating ground trenches for laying down pipes. The excavated material is typically aggregated into one or more work pile mounds, which are then transported to an offsite location. For various reasons, it is desirable to monitor the volumetric properties of these work pile mounds in an automated manner.

### SUMMARY

According to one broad aspect, there is provided a method for automated monitoring of volumetric properties of work pile mounds, comprising: obtaining monitoring sensor data of a surrounding environment which includes one or more work pile mounds, wherein the monitoring data comprises depth sensor data and motion sensor data; generating, based on the monitoring data, a three-dimensional (3D) construction of the surrounding environment; determining, based on the 3D construction, at least one volumetric property of a work pile mound in a target area; and generating an output that includes the determined volumetric properties.

In some examples, the depth sensor data comprises point cloud data, and the motion sensor data comprises relative position data.

In some examples, the monitoring data is generated by a sensor subsystem of a monitoring system, wherein the monitoring system is coupled to a ground vehicle.

In some examples, the sensor subsystem comprises a time of flight (ToF) sensor for generating the depth sensor data, and an inertial measurement unit (IMU) for generating the motion sensor data.

In some examples, the vehicle follows a vehicle path around a work pile mound.

In some examples, the work pile mound comprises a heap or a pile of material or objects, including heaps or piles of dirt, rock, gravel, asphalt or any other loose rock material.

In some examples, generating the 3D construction of the surrounding environment comprises: processing the depth sensor data to extract depth feature data including edge and planar features; identifying one or more work pile mounds based on the extracted edge features; and based on the motion sensor data and depth sensor data, applying a simultaneous localization and mapping (SLAM) technique, using a LiDAR-inertial odometry technique, to generate the 3D reconstruction of the environment which includes the relative positioning of the work pile mounds in the surrounding environment.

In some examples, the method further comprises transforming the extracted depth features into a global reference frame using location sensor data.

In some examples, the method further comprises determining the at least one volumetric property of a work pile mound in the target area comprises: applying triangulation to the target area to divide a surface into a plurality of non-overlapping triangles; generating a plurality of tetrahedrons from the plurality of triangles; determining the volume of each of the plurality of tetrahedrons; and summing the volumes of the plurality of tetrahedrons to determine a volume of the work pile mound in the target area.

In some examples, the method further comprises analyzing the time-stamped monitoring sensor data to determine a collision threat with an obstacle; if a collision threat is detected, determining the collision threat is above a threshold; and if the collision threat is above the threshold, generating a collision alert.

In another broad aspect, there is provided a monitoring system for automated monitoring of volumetric properties of work pile mounds, comprising: a sensor subsystem for generating monitoring sensor data; and at least one processor coupled to the sensor subsystem and configured for: obtaining monitoring sensor data of a surrounding environment which includes one or more work pile mounds, wherein the monitoring sensor data comprises depth sensor data and motion sensor data generated by the sensor subsystem; generating, based on the monitoring data, a three-dimensional (3D) construction of the surrounding environment; determining, based on the 3D construction, at least one volumetric property of a work pile mound in a target area; and generating an output that includes the determined volumetric properties.

In some examples, the depth sensor data comprises point cloud data, and the motion sensor data comprises relative position data.

In some examples, the monitoring system is couplable to a ground vehicle.

In some examples, the vehicle follows a vehicle path around a work pile mound.

In some examples, the sensor subsystem comprises a time of flight (ToF) sensor for generating the depth sensor data, and an inertial measurement unit (IMU) for generating the motion sensor data.

In some examples, the work pile mound comprises a heap or a pile of material or objects, including heaps or piles of dirt, rock, gravel, asphalt or any other loose rock material.

In some examples, generating the 3D construction of the surrounding environment comprises the at least one processor being further configured for: processing the depth sensor data to extract depth feature data including edge and planar features; identifying one or more work pile mounds based on the extracted edge features; and based on the motion sensor data and depth sensor data, applying a simultaneous localization and mapping (SLAM) technique, using a LiDAR-inertial odometry technique, to generate the 3D reconstruction of the environment which includes the relative positioning of the work pile mounds in the surrounding environment.

In some examples, the at least one processor being further configured for: transforming the extracted depth features into a global reference frame using location sensor data.

In some examples, determining the at least one volumetric property of a work pile mound in the target area comprises the at least one processor being further configured for: applying triangulation to the target area to divide a surface into a plurality of non-overlapping triangles; generating a plurality of tetrahedrons from the plurality of triangles; determining the volume of each of the plurality of tetrahedrons; and summing the volumes of the plurality of tetrahedrons to determine a volume of the work pile mound in the target area.

In some examples, the at least one processor is further configured for: analyzing the monitoring sensor data to determine a collision threat with an obstacle; if a collision threat is detected, determining the collision threat is above a threshold; and if the collision threat is above the threshold, generating a collision alert.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 illustrates an example environment in which the systems and methods disclosed herein may be applied.

FIG. 2A illustrates an example dump truck, having a monitoring system mounted thereon, approaching and circling around a work pile mound.

FIG. 2B illustrates an example excavator, with one or more monitoring systems mounted thereon, operating around a work pile mound.

FIG. 3 is an example system for monitoring both: (i) volumetric properties of target areas comprising work pile mounds, as well as (ii) monitoring for vehicle collision avoidance.

FIG. 4A is a process flow for an example method for monitoring volumetric properties of a target area comprising one or more work pile mounds.

FIG. 4B is a process flow for an example method for determining the volumetric properties of a work pile mound.

FIG. 4C is a process flow for an example method for user selected inputs of target areas comprising work pile mounds.

FIG. 4D is a process flow for an example method for determining the volumetric properties of a target area comprising a work pile mound.

FIG. 4E is a process flow for an example method for real-time or near real-time updating of the volumetric properties of work pile mounds.

FIG. 4F is a process flow for an example method for combining monitoring of volumetric properties of work pile mounds with vehicle collision avoidance.

FIGS. 5A-5C are various example graphical user interfaces (GUIs), including a GUI of a three-dimensional (3D) representation of a surrounding environment that includes one or more work pile mounds (FIG. 5A), a user input selection of a target area overlapping with a work pile mound (FIG. 5B) and output volumetric properties associated with a work pile mound (FIG. 5C).

FIG. 6 is an example electrical hardware configuration for a monitoring system.

Further aspects and features of the example embodiments described herein will appear from the following description taken together with the accompanying drawings.

### DETAILED DESCRIPTION

Examples herein provide for a method and system for automated monitoring of volumetric properties of work pile mounds. In at least one example application, the disclosed methods and systems are used in a construction environment, as explained herein.

### I. Definitions

Any term or expression not expressly defined herein shall have its commonly accepted definition understood by a person skilled in the art. As used herein, the following terms have the following meanings.

“Ground vehicle” refers to any wheeled, tracked, or otherwise mobile machine designed to travel over the ground surface for transporting materials, equipment, or personnel. This includes, but is not limited to, trucks, loaders, bulldozers, excavators, and autonomous or semi-autonomous vehicles configured for on-site material handling or transport operations.

“Volumetric property” refers to a characteristic of a work pile mound that relates to its three-dimensional spatial extent, including a volume of the work pile mound or any other feature derivable from volume.

“Work pile mounds” refers to accumulations, heaps or piles of particulate or bulk material, such as soil, rock, dirt, gravel, sand, asphalt, or similar loose material substances, that are temporarily deposited at a worksite, e.g., for the purpose of construction, landscaping, roadwork, excavation, or other industrial or infrastructure-related activities.

### Ii. General Overview

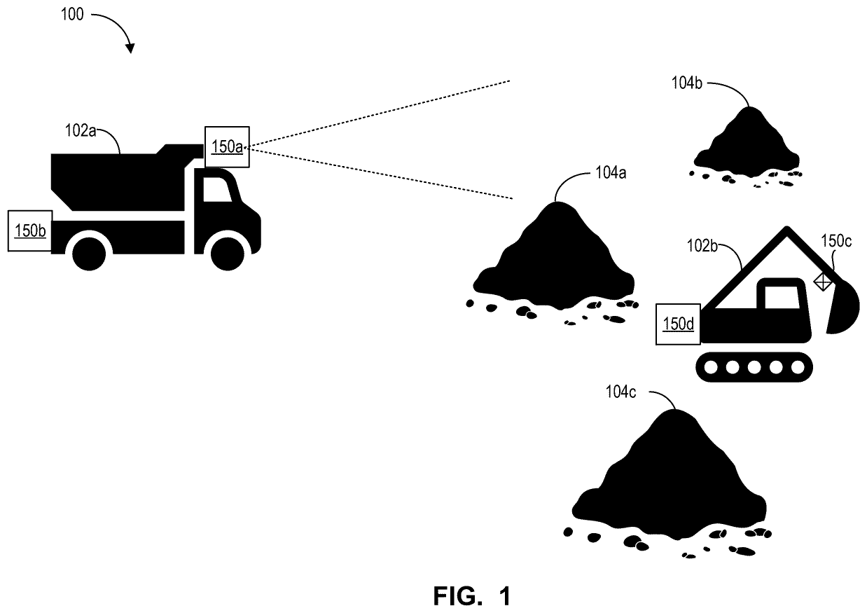

FIG. 1 illustrates an example environment (100) in which the systems and methods disclosed herein may be applied. It is understood, however, that the environment (100) is only exemplary, and disclosed examples can be applied to other environments and applications.

As shown, example environment (100) comprises a construction site (100) which includes one or more work pile mounds (104a)-(104c).

Environment (100) can also comprise any other environment in which work pile mounds (104) are located. For instance, this includes various environments which involve excavation and/or depositing of materials, including mines, quarries, or any collection site for depositing dirt, gravel, asphalt or the like.

In this example, the environment (100) includes one or more vehicles for excavating material into the work pile mounds (104) and/or transporting out materials from a work pile mound (104). For instance, this includes a dump truck (102a) for transporting dirt from dirt piles (104a)-(104c) to an offsite location. Construction vehicles (102) also include excavator (102b) for excavating dirt from the ground into a dirt pile (104) and/or loading dirt from a dirt pile (104) into a dump truck (102).

To this end, it is often the case that construction site operators hire employees and/or contractors to operate vehicles (102) to handle dirt excavation and transport. The site operator will typically compensate each employee or contractor on a per dirt volume basis such that, for example, the employee/contractor is paid for the volume of dirt excavated and/or transported out over time.

A challenge, however, is that the site operator is often unable to track the volume of dirt excavated and/or transported out over time, i.e., in order to properly compensate employees/contractors. For this reason, the site operator may rely on dedicated personnel to attend at the construction site and manually observe the increasing and/or decreasing volume of dirt piles (104). By monitoring the changing volume of dirt piles (104), the site operator is then able to monitor how much dirt was excavated and/or transported out, thereby determining how much to compensate the employees/contractors.

Nevertheless, because dedicated personnel are required to attend at the construction site, the process of monitoring the dirt pile volume is not only cost and time-intensive, but also highly subjective based on the personnels' subjective observations of the changing volume of each dirt pile. Further, as the number of dirt piles increases, the process becomes ever more complicated to monitor objectively.

Beyond compensating employees or contractors, there are also numerous other reasons where it is either useful or necessary to track the volumetric properties of work pile mounds (104). For example, a site operator may wish to determine whether a construction project or mining excavation project is proceeding on schedule, e.g., based on the volume of material excavated into work pile mounds (104). In all cases, the same problems are encountered relating to reliance on dedicated personnel to subjectively observe the changing volume of each work pile (104).

In view of the foregoing, systems and methods are provided herein for automated monitoring of volumetric properties of work pile mounds.

As shown in FIG. 1, disclosed examples provide for one or more monitoring systems (150). In some examples, monitoring systems (150) are coupled (e.g., mounted) to ground vehicles (102), e.g., construction vehicles, mining vehicles, or more generally, other vehicles used for earth moving applications, etc.

For instance, as illustrated, monitoring systems (150a), (150b) are coupled (e.g., mounted) to the dump truck (102a). Further, monitoring systems (150c), (150d) are mounted to the excavator (102b).

Monitoring systems (150) can be mounted to any desired portion of the vehicles, equipment, or piece of machinery (102). For example, the monitoring systems (150) can be mounted to a forward or rearward portion of a vehicle, equipment, or piece of machinery (102) to provide for forward or rearward detection. To this effect, there is no limitation on the number of monitoring systems (150) that can be coupled to each vehicle (102).

More generally, each monitoring system (150) accomplishes two functions:

The first function is that the monitoring system (150) automatically scans a target area comprising one or more work pile mounds or portions thereof, to generate monitoring sensor data. The monitoring data is processed to determine volumetric properties of the scanned work pile mounds.

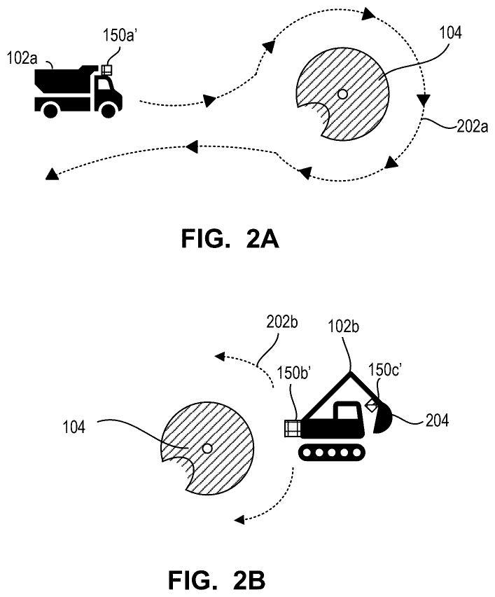

For instance, in FIG. 2A, monitoring system (150a′) is coupled to a dump truck (102a) such that, as the dump truck (102a) approaches and circles the dirt pile (104), the monitoring system (150a′) automatically scans the dirt pile (104). The collected monitoring data is then processed to determine the volume of dirt in the dirt pile mound (104). A similar concept is illustrated in FIG. 2B using the excavator (102b) and monitoring system (150b′).

In view of this, the monitoring system (150) provides an automated mechanism to monitor the volumetric properties of work pile mounds (104). In some examples, this allows an operator (e.g., of a construction or mining site) to track the volume of material excavated and/or transported offsite, and in an objective manner that does not rely on dedicated human personnel. Further, because the monitoring system (150) is couplable to vehicles, the monitoring is performed without interrupting the normal workflow (e.g., construction or mining workflow). That is, the monitoring system (150) can operate in the background while a dump truck (102a) and/or excavator (102b) is used for its usual routines, e.g., picking-up and/or dropping dirt. More broadly, the monitoring system (150) does not need to be coupled to specialized equipment, such as a flying drone.

A second function performed by the monitoring system (150) is that, in some examples, it can be used for detecting collisions between vehicles, pedestrians, and obstacles in the surrounding environment. These obstacles can include static obstacles (e.g., trees) or mobile obstacles (e.g., other vehicles or human personnel). If a likelihood of collision is detected, the monitoring system (150) may alert the vehicle operator. This, in turn, provides the vehicle operator sufficient time to stop the vehicle and/or re-route around the obstacle.

In the context of monitoring work pile volumes—an integrated collision avoidance functionality is of particular significance. This is because work piles (e.g., dirt or other rock piles) are typically surrounded by obstacles, including heavy construction equipment as well as human personnel. Enabling integrated collision avoidance therefore allows the monitoring system (150) to be used with large industrial vehicles (102) to both monitor work pile volumes, all the while allowing these vehicles to navigate challenging environments in a safe and secure manner.

In view of the foregoing, a unique aspect of the monitoring system (150) is that the dual work pile volume monitoring and collision avoidance monitoring functionalities are enabled using only a single integrated hardware system. That is, disclosed examples do not require separate sensing and processing systems to provide each of the two functionalities. This allows providing the monitoring system (150) in a small form factor, whereby the same sensors are used concurrently for both monitoring work pile volumes and collision avoidance, in an overlapping and concurrent manner.

Various aspects and features of the disclosed systems and methods are now described herein in greater detail.

### Iii. Example System

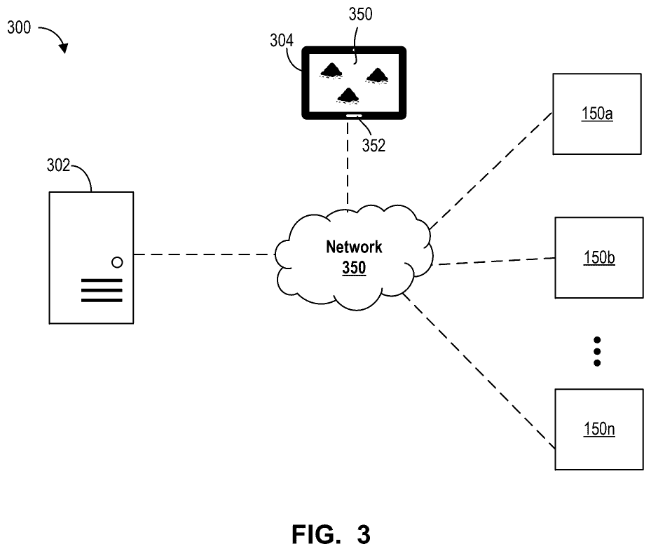

FIG. 3 shows an example system for monitoring of volumetric properties of work pile mounds, as well as for vehicle collision avoidance.

As shown, system (300) includes one or more monitoring systems (150a)-(150n). In some examples, monitoring systems (150a)-(150n) are coupled, via network (350), to one or more of a server (302) and a user device (304). As with all components described herein, although a single server (302) and user device (304) are illustrated, the system (300) may include any number of coupled or de-coupled servers (302) and/or user devices (304).

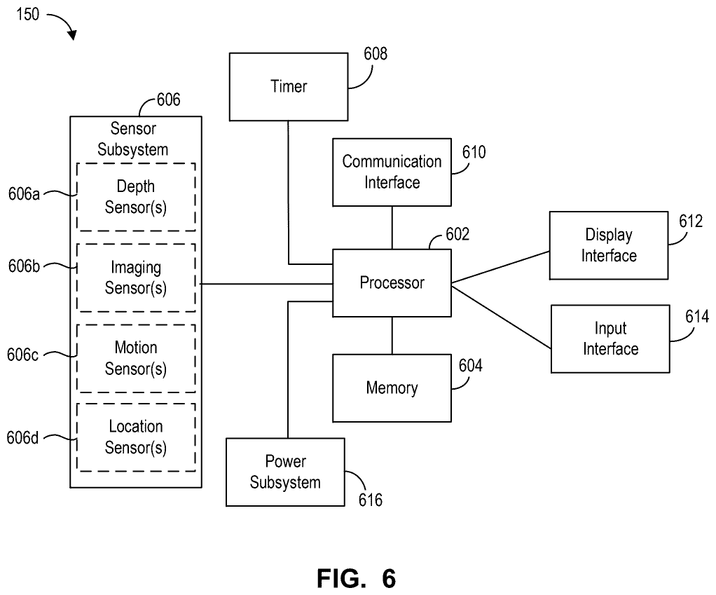

As provided herein, with reference to FIG. 6, each monitoring system (150) generally includes a processor (602) coupled to a memory (604) and a sensor subsystem (606). In some examples, processor (602) is also coupled to one or more of a timer (608), a communication interface (610), a display interface (612), an input interface (614) and a power subsystem (616).

While not explicitly illustrated, monitoring system (150) can also include an input/output (I/O) interface to couple to external computing elements. For example, it is possible that one or more of the components (604)-(616) is externally coupled directly and/or in-directly to the monitoring system (150), via the I/O interface.

In at least one example, sensor subsystem (606) includes one or more of: (i) depth sensor(s) (606a) (e.g., LIDAR or other time of flight (ToF) sensor data), (ii) imaging sensor(s) (606b) (e.g., cameras), (iii) motion sensor(s) (606c) (e.g., inertial measurement units (IMUs)), and (vi) location sensor(s) (606d) (e.g., Global Navigation Satellite System (GNSS) or a Global Positioning System (GPS)).

Continuing with reference to FIG. 3, server (302) can refer to any computer system, and can include its own processor coupled to a memory and a communication interface. In some examples, server (302) is a cloud server, as known in the art.

In at least one example, each monitoring system (150) is operable to transmit monitoring data to server (302), e.g., over network (350). For example, monitoring system (150) can transmit raw and/or partially processed data to server (302) for further processing and/or storage. In other examples, monitoring system (150) can transmit fully processed data to server (302), e.g., for storage and later retrieval.

It is possible that server (302) can receive monitoring data from two or more monitoring systems (150). For example, in FIG. 1, each of the monitoring systems (150) can transmit data to the same server (302). This, in turn, allows server (302) to update, in real-time or near real-time, its data on certain work pile mounds, e.g., as received from different monitoring systems (150).

User device (304), in FIG. 3, can include also any suitable computing device, including a desktop computer, a tablet or handheld computer or the like. User device (304) can include a processor, memory, communication interface, display interface (350) (e.g., for displaying graphical user interfaces (GUIs)) as well an input interface (352) for receiving user inputs.

In use, user device (304) allows a user operator to monitor data generated and collected by the monitoring systems (150). This can allow an operator to monitor the changing volume of work pile mounds, e.g., to determine how much material is remaining in a given mound.

In some examples, the user device (304) communicates with the server (302) to retrieve the relevant raw and/or processed data, generated by the monitoring systems (150). In other examples, user device (304) can communicate directly with the monitoring systems (150).

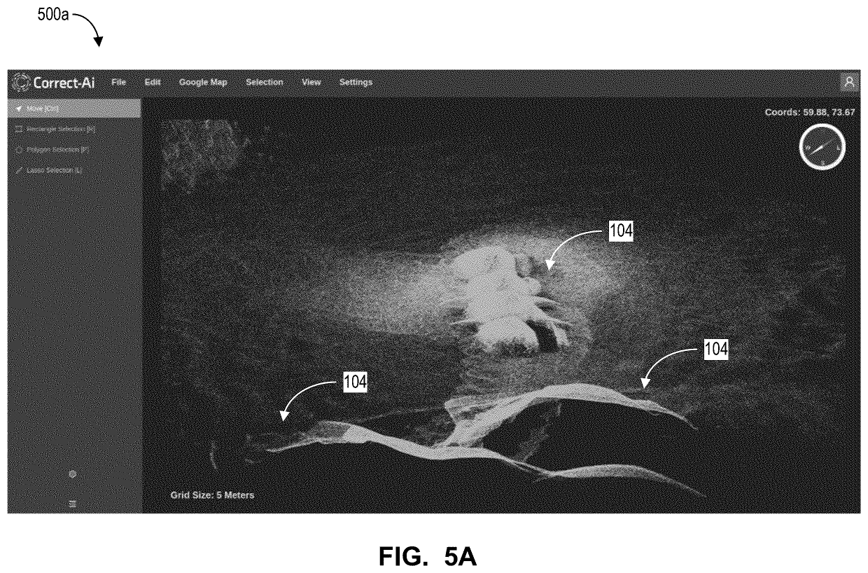

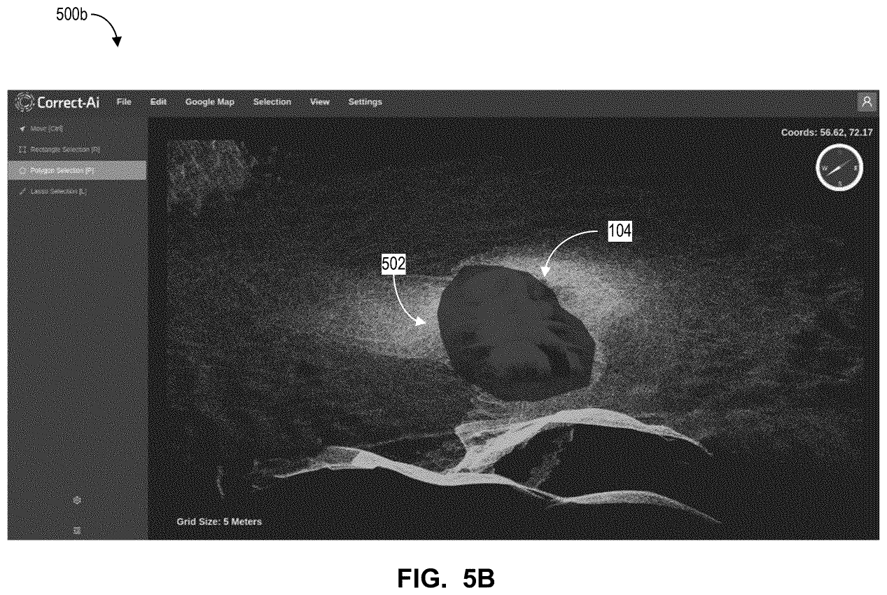

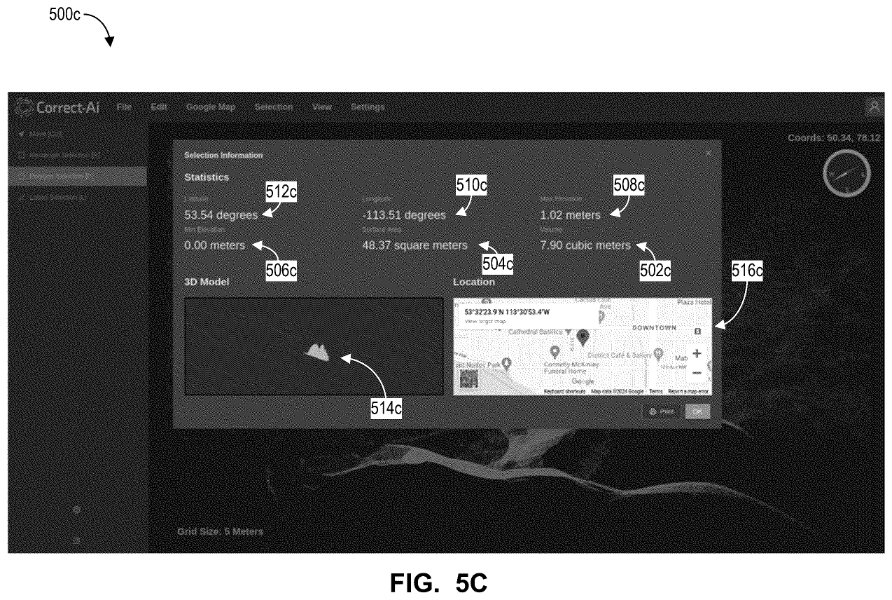

FIGS. 5A-5C illustrate various example graphical user interfaces (GUIs) that can be displayed on the user device (304).

FIG. 5A is a screenshot of a GUI (500a) with an image of a dirt pile (104). The image is generated and displayed on the user device (304) using processed data generated by a monitoring system (150).

FIG. 5B is a screenshot of a GUI (500b) providing an interface enabling a user to input a target area selection (502). Here, the user selects the target area (502) around a work pile mound (104) of interest. Based on this selection, the system determines volumetric properties of the selected work pile mound within the selected target area (502).

FIG. 5C is a screenshot of a GUI (500c) that illustrates the output data returned to the user, in response to the selection in FIG. 5B.

As shown, the output data can correspond to various volumetric properties of the selected work pile mound area (502). For example, the output data includes: (i) the volume of the work pile mound (502c), e.g., expressed in units of cubic meters; (ii) the surface area (504c) of the selected region (502), e.g., 48.37 square meters; and (iii) the minimum and maximum elevation of the work pile mound (506c), (508c).

The output data can also include various other location-based data, including the longitudinal location (510c) and the latitudinal location (512c) of the selected region, which helps the operator localize the work pile mound (104), e.g., for future reference. In at least one example, the GUI (500c) also displays a 3D visual representation of the work pile mound (514c), as well a map location identifier (516c).

Accordingly, the GUIs enable the user to monitor in real-time, or near real-time, the volumetric properties of various work pile mounds of interest using the user device (304).

### Iv. Example Methods

The following is a discussion of example general methods for using the disclosed systems. The disclosed methods may be executed by one or more of the processor (602) of monitoring system (150) (FIG. 6), as well as the processors of the server (302) and/or user device (304) (FIG. 3).

### (i.) General Method.

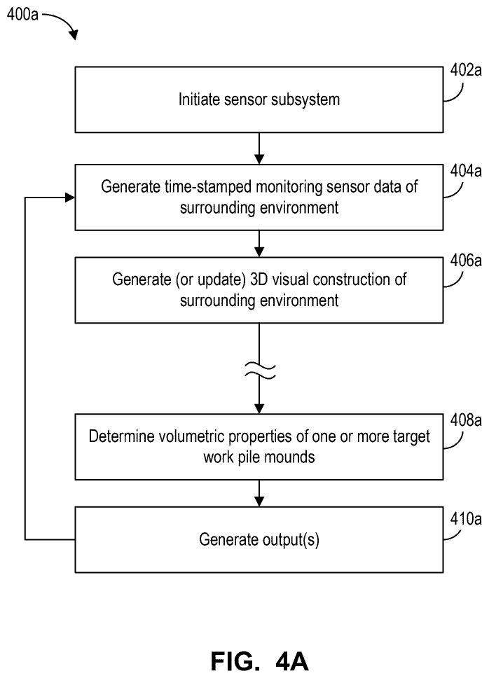

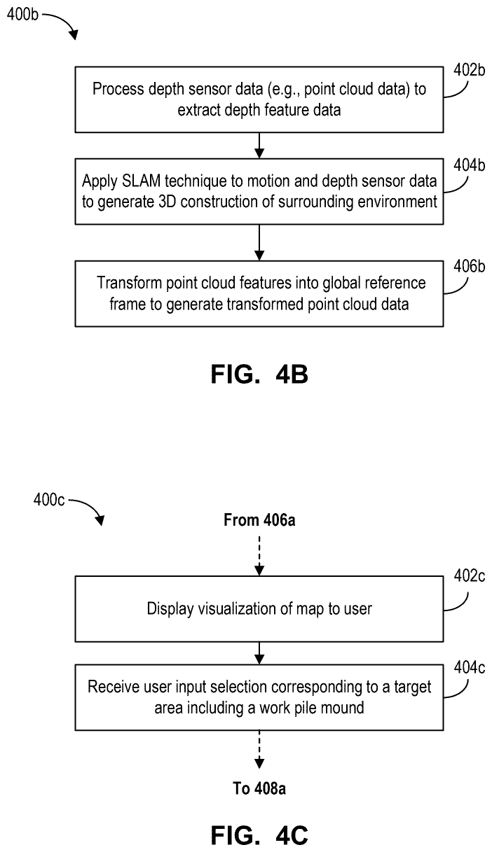

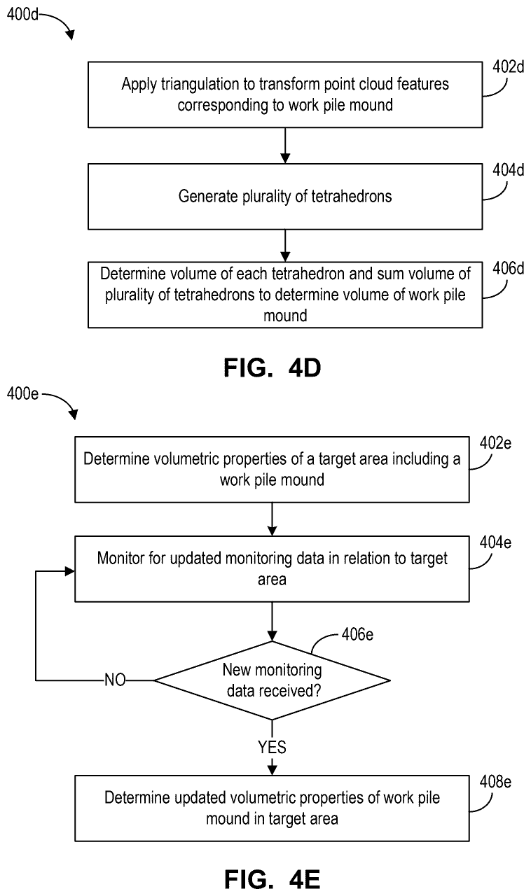

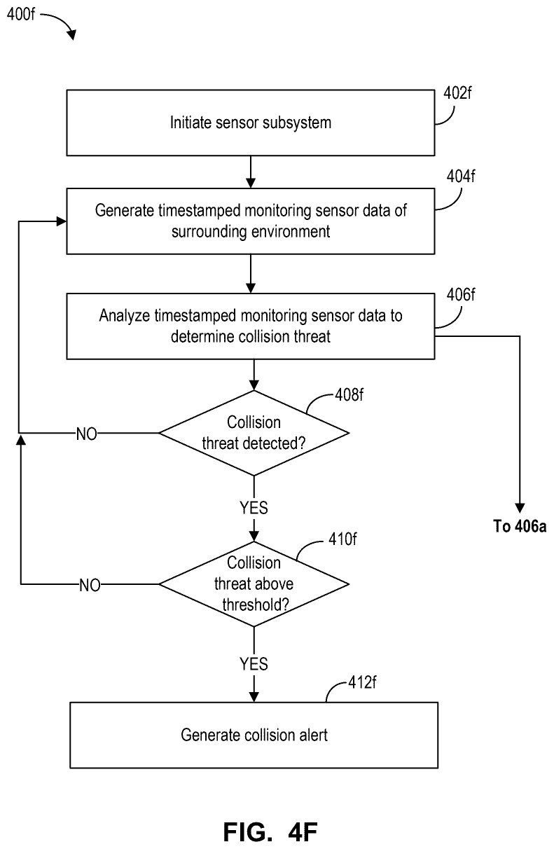

FIG. 4A is a process flow for an example method (400a) for monitoring volumetric properties of work pile mounds.

As shown, at (402a), the sensor subsystem (606), of monitoring system (150), is initiated (e.g., activated or powered-on) to begin generating monitoring sensor data (also referred to herein interchangeably as “sensor data” and/or “monitoring data”).

In some examples, act (402a) is performed once when initializing or starting the monitoring system (150) and/or the associated vehicle (102). In other examples, act (402a) is performed only if the vehicle (102) (e.g., a dump truck or excavator) is approaching a work pile mound. For example, in FIG. 2A, as the dump truck (102a) is approaching the dirt pile (104), it can activate the sensor subsystem (606) to begin collecting monitoring data.

At (404a), the monitoring system (150) generates monitoring sensor data of the surrounding environment which includes one or more work pile mounds (104).

For example, in FIG. 2A, monitoring data of the surrounding environment is generated as the dump truck (102a) is driving around the work pile (104). For example, sensor data is generated as the vehicle (102) follows a vehicle path (202) that partially or fully surrounds the work pile mound (104).

In some examples, the vehicle path (202) should sufficiently surround (e.g., encircle) the work pile (104) to enable collecting enough sensor data—from different angles around the work pile (104)—to allow determining the volumetric properties of a given work pile (104). In at least one example, sensor data is collected from a 360° perspective view of a given work pile mound (104).

By way of example, in FIG. 2A, the vehicle path (202a) may fully surround (e.g., encircle) the work pile mound (104) to enable sensor data to be collected with a 360° view of the work pile mound (104).

In other examples, as shown in FIG. 2B, the vehicle path (202b) may only partially surround (e.g., encircle) the work pile mound (104), e.g., by a 180° circumference. In this case, if the field of view of the sensor subsystem (606) is itself a 180° view, then a 180° circumference vehicle path (102b) provides sufficient 360° view sensor data to determine volumetric properties of the work pile (104).

In some examples, the monitoring system (150) is positioned on the vehicle (102) to provide line-of-sight for the sensor subsystem (606) with respect to the work piles (104). For example, the monitoring system (150) can be positioned at the front or back of the vehicle (102).

It will be understood that monitoring data does not need to be necessarily generated at a construction site. For example, the monitoring data can relate to any other work pile (104) in any other location or environment, e.g., a mine or quarry.

Various types of sensor monitoring data may be generated at act (404a) in FIG. 4A. This includes depth sensor data using the depth sensor (606a) (e.g., point cloud data), image sensor data using the image sensor (606b) (e.g., color or black-and-white images), motion sensor data using the motion sensor (606c) (e.g., accelerometer and rotational data) and/or location sensor data using the location sensor (606d) (e.g., vehicle GPS coordinates). In some examples, at each given time interval, one or more of the sensors concurrently generate respective sensor data.

In at least one example, the monitoring data is timestamped to generate time-stamped monitoring data. For example, the timestamp is generated based on the timer (608) in the monitoring system (150) (FIG. 6). In this manner, the monitoring data is associated with a corresponding timestamp, indicating when the monitoring data was collected.

If the monitoring data includes multiple types data—e.g., collected concurrently from different sensors at the same time instance-then each of type of sensor data may be associated with the same timestamp. For example, at each given time instance (tx), the sensor subsystem (606) can generate depth data and motion data, and each of the depth and motion data is associated with same timestamp (tx). Accordingly, the same time-stamped data can be analyzed together to generate a construction at the same time instance.

Continuing with reference to FIG. 4A, at (406a), based on the collected monitoring sensor data, the system processes the sensor data to generate a 3D construction (e.g., 3D rendering or map) of the surrounding environment. The 3D construction of the surrounding environment includes a three-dimensional representation of each work pile mound (104), and further, localizes the relative positioning of each work pile mound (104) within the surrounding environment, e.g., relative to other features in the surrounding environment. This is shown for example in FIG. 5A, which illustrates a rendering of the mapped/visualized environment with the localized work pile mound (104).

At (408a), the system can determine volumetric properties of one or more target work pile mounds (104). For example, this involves determining the volumetric properties of the dirt pile (104) in FIG. 2A.

In some examples, as explained in FIG. 4C, volumetric properties are determined at (408a) for target work pile mounds that are user selected. In other examples, volumetric properties are automatically determined for each sensed or detected work pile mound.

At (410a), an output is generated which includes various volumetric properties of the target work pile mounds (104). This includes the volume of the work pile (e.g., units of cubic meters), as well as the maximum and minimum elevation of the work pile. The output can be in any desired form. For instance, the output can be visual GUI (500c) as shown in FIG. 5C. In other examples, the output can be in the form of a document (e.g., a PDF file).

In at least one example, a comparative output is generated at (410a). For instance, method (400a) can iterate multiple times at different time instances, to generate volumetric properties of specific work pile mounds (104) over time (e.g., a day or a week). Accordingly, at (410a), the system can compare the volume of a work pile at a first time instance (e.g., morning) against a second time instance (e.g., afternoon). The output then corresponds to a difference or change in the work pile volume between the two time instances. This type of output can assist a user operator to track volume changes of the work pile over time.

As shown in FIG. 5C, the output at (410a) can also include global location parameters (510c), (512c), (516c). The location parameters can be generated based on location data generated by the location sensor(s) (602d), and which indicate the location and/or position of the target work pile (104). In other examples, which are discussed below, the location data is derived based on data generated from one or more of the motion sensor(s) (606c) and/or imaging sensors (606b).

In view of the foregoing, method (400a) provides an automated technique for monitoring the volume of work pile mounds over time, and in an objective manner.

In some examples, in method (400a) (FIG. 4A), after act (406a) and prior to act (408a), the system can initially determine the presence of a work pile mound. For example, if the target area includes a flat area, this may be indicate no work pile mounds and no further calculations are made.

### (ii.) Generating Map of Surrounding Environment.

FIG. 4B shows a process flow for an example method (400b) for generating a 3D construction (e.g., rendering or map) of the surrounding environment, which includes a mapping and localization of various work pile mounds (104) in that environment.

Method (400b) can be performed as part of act (406a) of method (400a) (FIG. 4A).

At (402b), the timestamped depth sensor data, comprising point cloud data, is processed to extract depth feature data. This can involve processing the point cloud data to extract planar and edge features of the environment. The extracted depth feature data (e.g., planar and edge features) allows identification of the boundaries of various work piles in the environment. In some examples, as known in the art, surfaces/planes are extracted based on the smoothness of a surface formed by a point with its neighbors, while edges are determined if a point has less than a threshold of neighbors.

At (404b), a simultaneous localization and mapping (SLAM) technique is applied to localize and map the relative positioning of the different work pile mounds (104) in the environment.

More generally, SLAM allows localizing and mapping the work pile positions relative to the vehicle path (202). By localizing and mapping the work pile positions relative to the vehicle path (202), the system is able to generate accurate volumetric calculations of these work piles (104) using the depth sensor data.

To this end, an appreciated challenge with performing SLAM is that these algorithms are computationally intensive. For example, most SLAM techniques rely exclusively on the use of LiDAR sensors-however, large computational power and memory capacity is required to collect and process, in real-time or near real-time, the large amount of 3D points generated by LiDAR sensors (606a), or any other depth sensor. The computationally intensive requirements for SLAM maybe an issue when deploying SLAM using the monitoring system (150). More generally, because the monitoring system (150) is a portable system that is deployed (e.g., installed) on vehicle (e.g., as an edge device), the system has limited processing and computational power which may not accommodate conventional LiDAR-exclusive SLAM algorithms for mapping work piles in real-time or near real-time.

Accordingly, in order to mitigate these issues, disclosed examples perform SLAM using a combination of the depth sensor (606a) (e.g., LiDAR) and the motion sensor (606c) that generates inertia data (e.g., IMU data, or otherwise acceleration and/or orientation data). The IMU data can offset reliance only on point cloud data generated by the LiDAR, which is high volume and computationally intensive to process. In some examples, the IMU is operated at a higher frequency than the LiDAR to reduce the amount of LiDAR data generated and processed.

In at least one example, the SLAM technique at (404b) is selected from a class of SLAM techniques that use the combination of LiDAR and IMU data, and thereby enable acquiring accurate, low-latency state estimations and dense 3D mapping with limited onboard computational processes. These classes of SLAM techniques are also known in the art as “LiDAR-inertial odometry” techniques or algorithms, which combine LiDAR and inertial data to measure distances to surrounding surfaces. By way of non-limiting examples, the following LiDAR-inertial odometry techniques can be used at acts (404b), as well as (406b):
FAST-LIO2 technique, as described in W. Xu, Y. Cai, D. He, J. Lin and F. Zhang, “FAST-LIO2: Fast Direct LiDAR-Inertial Odometry,” in IEEE Transactions on Robotics, vol. 38, no. 4, pp. 2053-273 August 2022, doi: 10.1109/TRO.2022.3141876 (referred to herein as “Xu et al”), the entire contents which are incorporated herein by reference.
LIOM technique, as described in H. Ye, Y. Chen, and M. Liu, “Tightly coupled 3d lidar inertial odometry and mapping,” in 2019 International Conference on Robotics and Automation (ICRA). IEEE, 2019, pp. 3144-3150, the entire contents which are incorporated herein by reference.
LILIOM technique, as described in K. Li, M. Li, and U. D. Hanebeck, “Towards high-performance solid state-lidar-inertial odometry and mapping,” IEEE Robotics and Automation Letters, vol. 6, no. 3, pp. 5167-5174, 2021, the entire contents which are incorporated herein by reference.
FAST-LIO technique, as described in W. Xu and F. Zhang, “Fast-lio: A fast, robust lidar-inertial odometry package by tightly-coupled iterated kalman filter,” IEEE Robotics and Automation Letters, pp. 1-1, 2021, the entire contents which are incorporated herein by reference.

While these techniques have been previously applied in the context of autonomous robot control and navigation, the inventors have appreciated a unique application to enable the use of an onboard or edge monitoring system (150) with limited computational resources and processing power, deployable on vehicles such as to determine volumetric properties of work pile mounds.

In some examples, SLAM is also formed using the imaging sensors (606b) (e.g., camera), using a LiDAR-inertial-visual SLAM technique, which further combines image data. An example of such technique is described in J. Lin and F. Zhang, “R3LIVE: A Robust, Real-time, RGB-colored, LiDAR-Inertial-Visual tightly-coupled state Estimation and mapping package,” 2022 International Conference on Robotics and Automation (ICRA), Philadelphia, PA, USA, 2022, pp. 10672-10678, doi: 10.1109/ICRA46639.2022.9811935, the entire contents which are incorporated herein by reference.

At (406b), based on the SLAM output, the mapped and localized depth feature data is transformed into a global reference frame. This can be performed by associating the depth feature data with global location coordinate data (e.g., GNSS data). For example, point cloud data is associated with corresponding location data (e.g., GPS), e.g., as determined by the location sensors (606d). Accordingly, the point cloud data-including the depth feature data (e.g., extracted edge and planar data)—is translated into a global reference coordinate frame.

In this manner, a 3D construction (e.g., rendering or map) of the surrounding environment is generated, which includes a three-dimensional (3D) reconstruction of the environment with surrounding work pile mounds. The map includes a 3D visualization of the various work pile mounds, based on the processed depth sensor data (e.g., point cloud data). The map further indicates the relative positioning of various work pile mounds (104) in the environment based on the SLAM technique. Each of the work pile mounds (104) is also identifiable through a global positioning reference frame based on act (406b).

The generated 3D mapped environment can be stored on the server (302) (FIG. 3) or any other memory for later retrieval, e.g., by user device (350). The 3D mapped environment may also be updated, e.g., in real-time or near real-time, based on new monitoring sensor data receiving from a monitoring system (150).

### (iii.) User Selection of Target Area.

The operator of user device (304) (FIG. 3) may be provided with an option to select a target area where a work pile is located.

For example, in FIG. 5A, the user device (304) can display a GUI (500a) comprising a 3D map visualization of the surrounding environment, e.g., as generated by FIG. 4B.

In this example, as best shown in FIG. 5B, the user selects a target area (502) corresponding to one or more work pile mounds (104), or any portion thereof. In turn, the system can generate volumetric properties of the work pile mound(s) (104), within the selected target area (502). In this manner, the system provides the user with greater control in determining the volumetric properties of specific work piles of interest, to allow for targeted monitoring.

FIG. 4C is a process flow for an example method (400c) for monitoring volumetric properties of target work pile mounds (104) based on user-selected inputs.

In some examples, method (400c) is executed by one or more of the processor (602) of monitoring system (150) (FIG. 6), as well as the processors of the server (302) and/or user device (304) (FIG. 3).

As shown, at (402c), after the three-dimensional (3D) construction map of the surrounding environment is generated at (406a), the user device (304) can display a visualization of the 3D map construction to the user operator (e.g., FIG. 5A). In other cases, the visualization can be displayed in any other format (e.g., via a document, such as a PDF file).

At (404c), a user input selection is received, corresponding to a selected target area of interest. The selected target area can include one or more work pile mounds (104), or portions thereof. The user input selection is received, for example, via an input interface of the user device (304).

As noted previously, an example of the user selection is exemplified in the GUI (500b) of FIG. 5B. As shown, the target area selection (502) is made by the user around the work pile (104). This allows the user to select the specific work pile (104) in respect of which to monitor the volume of material. In making this selection, the system omits (e.g., excludes) the negative area around the selected target area (502) while performing the volumetric calculations.

While GUI (500b) shows the entire work pile (104) as being selected, it is also possible for the user to only select the target area as a portion of the work pile (104).

The method can then return to act (408a) (FIG. 4A) to determine the volumetric properties of the work pile mound(s), or portions thereof, in the selected target area.

### (iv.) Method for Determining Volumetric Properties of Work Pile Mounds.

FIG. 4D shows a process flow for an example method (400d) for automated determination of volumetric properties of a target area comprising a work pile mound. Method (400d) may be applied during act (406a) of method (400a) (FIG. 4A).

At (402d), triangulation is applied to transform point cloud features of a work pile mound (104), e.g., in a selected target area, to generate a triangulated 3D model of the work pile mound. In some examples, the triangulation of the point cloud generates a mesh, whereby the mesh is defined by a plurality of triangles that cover over the surface of the work pile mound captured by the point cloud data. This mesh encloses at least some of the amount of volume between the surface and the ground plane

In at least one example, the surface of the work pile mound (104) is divided into non-overlapping triangles. It will be appreciated that the SLAM technique used for 3D reconstruction, at (404b) (FIG. 4B), facilitates the relative sizing and dimensioning of the non-overlapping triangles based on which area of the work pile mound is triangulated, e.g., based on relative location of the triangulated area in the work pile mound as determined by the SLAM technique.

At (404d), based on the applied triangulation, a plurality of non-overlapping tetrahedrons are generated. In at least one example, each tetrahedrons is generated extending the triangles all the way to the ground plane.

At (406d), the volume of each individual tetrahedron is calculated using geometric principles known in the art, wherein each such tetrahedron-specific volume represents the volume of material in a given area of the work pile mound overlapping with the tetrahedron. Further, the sum of all tetrahedron volumes is determined to estimate the volume sum of the target work pile mound. In some examples, a reference plane (e.g., ground level) is used for determining the volume sum, e.g., as determined from the planar feature extraction from the point cloud data.

In some examples, the method (400d) is used because it requires low computational processing, which is suited for the portable monitoring system (150).

### (v.) Method for Monitoring Volumetric Properties of a Target Area.

FIG. 4E shows a process flow for an example method (400e) for updating the volumetric properties of a target area which comprises a work pile mound, or a portion thereof. Method (400e) may be executed during acts (408a)-(410a) of method (400a) (FIG. 4A).

At (402e), the volumetric properties of a target area comprising a work pile mound is determined. This can be determined in a manner analogous to method (400a) (FIG. 4A). The system can associate the determined volumetric properties with the target area, based on the global reference frame data, generated at (406b) (FIG. 4B).

At (404e), the system monitors for updated monitoring data in relation to the target area, associated with the given global reference location. For example, this can be monitoring data generated by the same or a different monitoring system (150), which is mounted to the same or different vehicle.

At (406e), a determination is made as to whether new monitoring data is received. If so, at (408e), the volumetric properties of the target area are updated, e.g., in accordance with method (400a) (FIG. 4A).

### (vi.) Method for Combined Monitoring of Volumetric Properties of Work Pile Mounds and Collision Avoidance.

As explained above, disclosed examples allow the monitoring system (150) to provide dual functions of (i) monitoring volumetric properties of work pile mounds, and (ii) collision avoidance. These dual functionalities can be provided using a single integrated hardware system. The requirement for collision avoidance may be particularly important for ground vehicles that are driving around ground obstacles.

FIG. 4F provides an example process flow for a method (400f) for using the monitoring system (150) for both collision avoidance and volume monitoring functionalities.

In some examples, method (400f) is executed by one or more of the processor (602) of monitoring system (150) (FIG. 6), as well as the processors of the server (302) and/or user device (304) (FIG. 3).

At (402f), the sensor subsystem (606) is initiated, similar to act (402a) (FIG. 4A).

At (404f), time-stamped monitoring sensor data is generated as the vehicle (102) is driving around a work pile mound (104). This is analogous to act (404a) (FIG. 4A).

At (406f), the time-stamped monitoring sensor data is analyzed to determine any collision threats, or otherwise, determine the likelihood that the vehicle path (202) will collide with a stationary or mobile obstacle. This can be performed based on the depth sensor data (e.g., point cloud data) as well as the motion sensor data (e.g., acceleration data).

In at least one example, the collision threat level is determined in a manner analogous to that described in US Publication 2022/0067403 to Khonsarian et al, filed on Aug. 26, 2021 as U.S. application Ser. No. 17/446,099 (“Khonsarian et al”), the contents of which are incorporated herein in their entirety by reference.

More generally, this can involve the following process: (i) using the image data, from the imaging sensor (606b), to detect and classify the object (e.g., based on an object detection and classification model, as known in the art); (ii) processing the point cloud data, from the depth sensor (606a), to group points into a group representing the object; (iii) fusing the point cloud data with the image data to produce a fused data set frame; (iv) determining the object location from the fused data set frame and determining an object velocity relative to the vehicle by comparing the fused data set frame to a previous data set frame. In some examples, the velocity of the vehicle is determined based on motion sensor data (e.g., acceleration) from the motion sensor (606c); and (v) determining whether the object is an obstacle (e.g., a collision threat) based on the object location and relative velocity.

At (408f), a determination is made as to whether a collision threat is detected. As described in Khonsarian et al, this can be determined based on one or more of the object type, proximity to subject vehicle, as well as location and relative velocity.

If a collision threat is detected, then at (410f), it is determined whether the collision threat is above a threshold.

For example, as disclosed in Kohnsarian et al, if the obstacle is within a predetermined proximity of the vehicle (202) and/or is moving above a predetermined velocity, it can be determined to be real threat. If this is the case, at (412f), then a collision alert can be generated. The collision alert can be in any form (e.g., audio, visual and/or tactile). In some examples, the collision alert is a visual alert generated on the display interface (612), of monitoring system (150) (FIG. 6). If the vehicle is an automated vehicle, act (412f) can also include controlling the vehicle to stop or drive along an alternate path around the obstacle.

Otherwise, at (408f) or (410f) if no collision threat is detected, or the collision threat is not above the predetermined threshold-then the method returns to act (404f) to continue generating monitoring sensor data.

Concurrently or partially concurrently with acts (408f) to (412f)—after (406f), the method can also continue in parallel to act (406a) (FIG. 4A) to generate (or update) the 3D construction of the environment for the purposes of determining volumetric properties of work pile mounds.

Here, it is appreciated that in method (400a) and (400d), the same depth sensor data (e.g., point cloud data) and motion data (e.g., acceleration), generated by the depth sensor (606a) and motion sensor (606c) respectively, can be used simultaneously for collision avoidance as well as monitoring volumetric properties of a work pile mound. Accordingly, this allows for the same hardware system and data streams to be used for both purposes and reduces computational demand by minimizing the number of sensors generating data requiring processing. The reduced computational demand is required for on-board processing in the portable monitoring system (150). This feature is particularly useful for autonomous vehicles that are mounted with the monitoring system (150).

### V. Alternate and/or Specific Examples

The following is a discussion of various alternative and/or specific examples.

### (i.) Work Pile Mounds in Other Contexts.

While disclosed examples are described with reference to work pile mounds distributed in open spaces (e.g., a construction or mining site), the same principles can be applied to work pile mounds in any other context.

For example, in FIG. 2B, as the excavator (102b) is digging ground material using the attachment (204) (e.g., a bucket), the attachment is being loaded with excavated material. The material inside the attachment (204) therefore forms a work pile mound of sorts.

In this example, it is possible to use the monitoring system (150c) to monitor the amount of material loaded into the attachment 204. For example, the monitoring system (150c) is mounted to the excavator arm to provide the sensors a line-of-sight into the attachment (204). When the excavator (102b) loads the attachment (204) with material, the monitoring system (150c) is used to determine how much material was loaded into the attachment (204). This is performed using method (400a) (FIG. 4A), e.g., but without the necessity of performing act (406a).

### (ii.) Partial Estimates of Volumetric Properties of Work Pile Mounds.

As discussed in method (400a) (FIG. 4A), the vehicle (102) follows a vehicle path (202) that surrounds the entirety of the work pile mound, e.g., to generate sufficient sensor data to determine the work pile's volumetric properties.

In other examples, however, it is possible to determine volumetric properties based only on partial sensor data of the work pile. For example, if the vehicle path (202) only generates sensor data covering a portion of the work pile mound, method (400a) can still be performed to generate an estimate of the work pile volume, based on the available data. In this manner, work pile volumes can be generated if the vehicle (102) is only passing by a work pile mound (104), as opposed to driving around it.

### (iii.) Example SLAM Technique Using FAST-LIO2.

As discussed above, with reference to method (400b) of FIG. 4B—at act (404b) a SLAM technique is used to generate a 3D reconstruction of the environment.

In at least one example, acts (404b) and (406b) in method (400b) are performed using a FAST-LIO2 technique, as described in Xu et al (see above).

While the FAST-LIO2 has been applied previously to autonomous robot control and vehicle navigation, a unique advantage is appreciated in applying this technique in the context of monitoring system (150). In particular, the FAST-LIO2 technique enables obtaining limited, low-latency state estimation and 3D mapping with limited onboard computational resources.

More generally, as stated previously, in contrast to many SLAM techniques that rely only on LiDAR data, the FAST-LIO2 technique enables reducing computational processing load by combining LiDAR data with less intensive IMU data, e.g., obtained from motion sensor(s) (606c).

As described in Xu et al., FAST-LIO2 treats the IMU's first frame as the global frame, while the LiDAR is sampled at a smaller frequency than the IMU. The algorithm takes as input the IMU measurements (position and attitude), and the LiDAR scans.

An iterated Kalman filter is used to track and update several variables over the course of map generation, including: (i) IMU position and attitude in a global frame; (ii) LiDAR position and attitude with respect to IMU; (iii) linear and angular velocities of IMU; (iv) biases of the IMU; and (v) gravity vector in the global frame.

More particular, the iterated Kalman filter is used to track and update these parameters, and operates in two phases, namely: (i) a forward propagation, and (ii) a backward propagation. These parameters, along with a state transition function, cumulatively constitute a kinematic model, wherein given a previous estimate of the parameters, and the state transition function, the current estimate of the parameters are obtained for localizing, and in turn mapping using LiDAR data.

In some examples, current estimate of the map is saved as a point cloud tree data structure. In some examples, the tree data structure is a k-d tree, which as explained in Xu et al, allows for an efficient k-nearest neighbor search (kNN search), which in turn allows for efficient updating of the point cloud tree data for real-time mapping.

With respect to the forward and backward propagation:

In the forward propagation step, the previously estimated parameters and a discretized version of the state transition function are used to obtain current estimate of the position and attitude of the IMU and LiDAR in the global frame. Using the predicted parameters, and the current LiDAR scan, the points in the current scan are projected (e.g., transformed) to the global frame. From these transformed points, a search is conducted for closest map points closest in the tree data structure.

In the back propagation step, the residual of these transformed points are fitted on a plane along with the map points currently closest to them. This residual is minimized iteratively using an iterated Kalman filter until convergence of parameter values has achieved, i.e., the parameter values have stabilized to an appropriate value whilst minimizing the residual. Finally, these newly transformed points are added to the tree data structure, and the forward and backward propagation passes are repeated again for the next set of LiDAR and IMU scans. More generally, the algorithm uses an IMU to compensate each point's motion via a rigorous back-propagation step and estimates the system's full state via an on-manifold iterated Kalman filter. In some examples, in between two LiDAR scans, forward propagation is performed multiple times using the IMU measurements. When enough LiDAR points have been accumulated, the residual is determined and backward propagation performed. This enables less reliance on LiDAR data, which is computationally intensive to process on a per frame basis. Lastly, the IMU's rotation, i.e., the attitude (yaw-pitch-roll) values are used in the calculation.

To that end, a unique aspect of the FAST-LIO2 method is that it is adapted to increase computational speeds for SLAM using a mathematically equivalent formula of computing the Kalman gain, which also reduces computational complexity.

### V. Example Hardware Configuration for Monitoring System

FIG. 6 shows an example hardware configuration for a monitoring system (150).

As shown, monitoring system (150) can include a processor (602) coupled to a memory (604) and a sensor subsystem (606). In some examples, processor (602) is also coupled to one or more of a timer (608), a communication interface (610), a display interface (612), an input interface (614) and a power subsystem (616).

Processor (602) refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), field programmable gate arrays (FPGA) and digital signal processors.

Memory (604) refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

It will be understood by those of skill in the art that references herein to monitoring system (150) as carrying out a function or acting in a particular way imply that processor (602) is executing instructions (e.g., a software program) stored in memory (604) and possibly transmitting or receiving inputs and outputs via one or more interfaces.

Sensor subsystem (606) includes various sensor units used for scanning the surrounding environment. This includes scanning a target area where a work pile mound (104) is located. Sensor subsystem (606) can also be concurrently used to scan the environment to avoid collisions between the vehicle and surrounding obstacles.

In some examples, sensor subsystem (606) includes one or more: (i) depth sensor(s) (606a), (ii) imaging sensor(s) (606b), (iii) motion sensor(s) (606c), and (vi) location sensor(s) (606d).

Depth sensor(s) (606a) include one or more sensors which generate depth data with respect to the surrounding environment. In some examples, these include time-of-flight (ToF) sensors, such as LiDAR sensors. The generated depth data can include point cloud data, as known in the art, where each data point is associated with a point coordinate (e.g., x, y and z) in the environment.

Imaging sensor(s) (606b) include any sensors that can generate image data of the environment. For example, this includes various types of cameras known in the art (e.g., color, RGB and/or black and white cameras).

Motion sensor(s) (606c) are used to track motion of the monitoring system (150)—and by extension, the vehicle (102) associated with the monitoring system (150)—by generating motion data. In at least one example, the motion sensor (606c) can include an inertial measurement unit (IMU) or the like. In other examples, they can include individualized accelerometers, gyroscopes and other similar sensor devices.

Location sensor(s) (606d) include sensors that generate location data to track the location of the monitoring system (150), and by extension the vehicle (102) associated with the monitoring system (150). For example, this can include a global navigation satellite system (GNSS), or a Global Positioning System (GPS).

In some cases, the location sensor(s) (606d) are not necessary. For example, the monitoring system (150) may be able to track its location using the motion sensor(s) (606c) in conjunction with a reference map of the environment. For instance, based on the direction and velocity of detected motion, the monitoring system (150) can determine changes in the vehicle's location in its environment.

Timer (608) can include any type of clock or the like which is used to track time.

Communication interface (610) is any interface (e.g., an antenna) that allows the system (150) to transmit and/or receive data from external computing systems. This includes communicating, over network (350) (FIG. 3), with one or more of the cloud server (302) and/or user device (304).

In some examples, monitoring system (150) may also include a display interface (612) and an input interface (614).

Display interface (612) can include any interface for displaying output data (e.g., graphical and/or textual data), including an LCD screen or the like. In some cases, display interface (410) displays a graphical user interface.

Input interface (614) can include any interface for receiving user-input data, and may include keyboard buttons, etc. It is possible that input interface (412) and display interface (410) are one of the same, such as in the case of a touchscreen display.

Power subsystem (616) can include an energy storage or delivery medium, such as a battery or power outlet.

While not explicitly illustrated, each of the server (302) and user device (304) can also similarly include a processor coupled to a memory, as a communication interface, display interface and input interface, as described herein.

### Vi. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for automated monitoring of volumetric properties of work pile mounds, comprising:
obtaining monitoring sensor data of a surrounding environment which includes one or more work pile mounds, wherein the monitoring data comprises depth sensor data and motion sensor data;
generating, based on the monitoring data, a three-dimensional (3D) construction of the surrounding environment;
determining, based on the 3D construction, at least one volumetric property of a work pile mound in a target area; and
generating an output that includes the determined volumetric properties.

2. The method of claim 1, wherein the depth sensor data comprises point cloud data, and the motion sensor data comprises relative position data.

3. The method of claim 1, wherein the monitoring data is generated by a sensor subsystem of a monitoring system, wherein the monitoring system is coupled to a ground vehicle.

4. The method of claim 3, wherein the sensor subsystem comprises a time of flight (ToF) sensor for generating the depth sensor data, and an inertial measurement unit (IMU) for generating the motion sensor data.

5. The method of claim 3, wherein the vehicle follows a vehicle path around a work pile mound.

6. The method of claim 1, wherein the work pile mound comprises a heap or a pile of material or objects, including heaps or piles of dirt, rock, gravel, asphalt or any other loose rock material.

7. The method of claim 1, wherein generating the 3D construction of the surrounding environment comprises:
processing the depth sensor data to extract depth feature data including edge and planar features;
identifying one or more work pile mounds based on the extracted edge features; and
based on the motion sensor data and depth sensor data, applying a simultaneous localization and mapping (SLAM) technique, using a LiDAR-inertial odometry technique, to generate the 3D reconstruction of the environment which includes the relative positioning of the work pile mounds in the surrounding environment.

8. The method of claim 7, further comprising transforming the extracted depth features into a global reference frame using location sensor data.

9. The method of claim 1, wherein determining the at least one volumetric property of a work pile mound in the target area comprises:
applying triangulation to the target area to divide a surface into a plurality of non-overlapping triangles;
generating a plurality of tetrahedrons from the plurality of triangles;
determining the volume of each of the plurality of tetrahedrons; and
summing the volumes of the plurality of tetrahedrons to determine a volume of the work pile mound in the target area.

10. The method of claim 1, comprising:
analyzing the time-stamped monitoring sensor data to determine a collision threat with an obstacle;
if a collision threat is detected, determining the collision threat is above a threshold; and
if the collision threat is above the threshold, generating a collision alert.

11. A monitoring system for automated monitoring of volumetric properties of work pile mounds, comprising:
a sensor subsystem for generating monitoring sensor data; and
at least one processor coupled to the sensor subsystem and configured for:
obtaining monitoring sensor data of a surrounding environment which includes one or more work pile mounds, wherein the monitoring sensor data comprises depth sensor data and motion sensor data generated by the sensor subsystem;
generating, based on the monitoring data, a three-dimensional (3D) construction of the surrounding environment;
determining, based on the 3D construction, at least one volumetric property of a work pile mound in a target area; and
generating an output that includes the determined volumetric properties.

12. The system of claim 11, wherein the depth sensor data comprises point cloud data, and the motion sensor data comprises relative position data.

13. The system of claim 11, wherein the monitoring system is couplable to a ground vehicle.

14. The system of claim 13, wherein the vehicle follows a vehicle path around a work pile mound.

15. The system of claim 11, wherein the sensor subsystem comprises a time of flight (ToF) sensor for generating the depth sensor data, and an inertial measurement unit (IMU) for generating the motion sensor data.

16. The system of claim 11, wherein the work pile mound comprises a heap or a pile of material or objects, including heaps or piles of dirt, rock, gravel, asphalt or any other loose rock material.

17. The system of claim 11, wherein generating the 3D construction of the surrounding environment comprises the at least one processor being further configured for:
processing the depth sensor data to extract depth feature data including edge and planar features;
identifying one or more work pile mounds based on the extracted edge features; and
based on the motion sensor data and depth sensor data, applying a simultaneous localization and mapping (SLAM) technique, using a LiDAR-inertial odometry technique, to generate the 3D reconstruction of the environment which includes the relative positioning of the work pile mounds in the surrounding environment.

18. The system of claim 17, further comprising the at least one processor being further configured for:
transforming the extracted depth features into a global reference frame using location sensor data.

19. The system of claim 11, wherein determining the at least one volumetric property of a work pile mound in the target area comprises the at least one processor being further configured for:
applying triangulation to the target area to divide a surface into a plurality of non-overlapping triangles;
generating a plurality of tetrahedrons from the plurality of triangles;
determining the volume of each of the plurality of tetrahedrons; and
summing the volumes of the plurality of tetrahedrons to determine a volume of the work pile mound in the target area.

20. The system of claim 11, wherein the at least one processor is further configured for:
analyzing the monitoring sensor data to determine a collision threat with an obstacle;
if a collision threat is detected, determining the collision threat is above a threshold; and
if the collision threat is above the threshold, generating a collision alert.
